(19) United States
(12) Patent Application Publication
(10) Pub. No.: US 2006/0227924 A1
(43) Pub. Date: Oct. 12, 2006

(54) High heat flux rate nuclear fuel cladding and other nuclear reactor components

(75) Inventors: Lars G. Hallstadius, Vasteras (SE); Pablo R. Rubiolo, Pittsburgh, PA (US); Edward J. Lahoda, Pittsburgh, PA (US)

Correspondence Address: WESTINGHOUSE ELECTRIC COMPANY, LLC, P.O. BOX 355, PITTSBURGH, PA, 15230-0355, US

(73) Assignee: Westinghouse Electric Company LLC

(21) Appl. No.: 11/102,024

(22) Filed: Apr. 8, 2005

(51) Int. Cl. G21C 3/00

(52) U.S. Cl. 376/414; 376/416

(57) ABSTRACT

Structural forms, such as cladding for nuclear fuel (57) held within a supporting grids (54) within the environment of an aqueous cooled nuclear reactor vessel (32) housing a reactor core, where at least some of the structural forms are coated with or made from a ceramic having a melting point temperature over 1850° C.

### BACKGROUND OF THE INVENTION

In the development of nuclear reactors, such as pressurized water reactors and boiling water reactors, fuel designs impose significantly increased demands on all of the core strip and tubular cladding. Such components are conventionally fabricated from the zirconium-based alloys, such as Zircaloy-2, Zircaloy-4, Zirlo, etc. Increased demands on such components are in the form of longer required residence times, thinner structural members and increased power output per area, which cause potential corrosion and/or hydriding problems, as well as issues during design base accident conditions.

Patent descriptions relating to Zircaloy-2 or Zircaloy-4, can be found in U.S. Pat. Nos. 2,772,964 and 3,148,055, (Thomas et al. and Kass et al., respectively). Zircaloy-2 is generally a zirconium alloy having about 1.2-1.7, weight percent (all percents herein are weight percent) tin, 0.07-0.20 percent iron, about 0.05-0.15 percent chromium, and about 0.03-0.08 percent nickel-with the remainder being zirconium. Zircaloy-4 generally contains about 1.2-1.7 percent tin, about 0.18-0.24 percent iron, and about 0.07-0.13 percent chromium.

Other patents in this area include U.S. Pat. Nos. 5,194,101; 5,125,985; 5,112,573; and 4,649,023, (Worcester et al., Foster et al., Foster et al., and Sabol et al., respectively).

While zirconium and other metal alloys have excellent corrosion resistance and mechanical strength in a nuclear reactor environment under normal and accident conditions where the heat fluxes are relatively low, they encounter mechanical stability problems during conditions such as a departure from nucleate boiling (“DNB”) incident that might occur during accidental conditions. Any action tending to increase the heat flux of the core in order to raise the plant output will aggravate these problems.

The response of the fuel to an accident in a nuclear reactor is critical to whether or not a nuclear plant contains the accident and does not release radiation to the environment and people surrounding the reactor. One of the key requirements is that the fuel maintains a coolable geometry. That is, it must be able to keep its basic shape throughout the accident and allow water and steam to pass through the core to maintain temperatures below the point at which it would start to melt and bend into a form which cannot be cooled and heat easily removed from the reactor. In order for this restriction to be met for current metal based fuel clad, grids, and the like, the surface temperature is not allowed to rise above about 1200° C. at any point in the core during a loss of coolant accident. By keeping below this maximum temperature, the fuel rods in a core are guaranteed to maintain their integrity during any design basis accident. The maximum temperature that the clad, grids and the like gets to is a function of the amount of decay heat that is generated and which in turn is related to the power that the reactor operates, and to the rate of reaction between the coolant and fuel rod cladding. The maximum temperature is also a function of the type of heat transfer that occurs between the fuel rod and the surrounding coolant during an accident. In order to balance the cooling heat transfer and the heat generation while still maintaining the required surface temperature, a condition called departure from nucleate boiling (DNB) must be avoided.

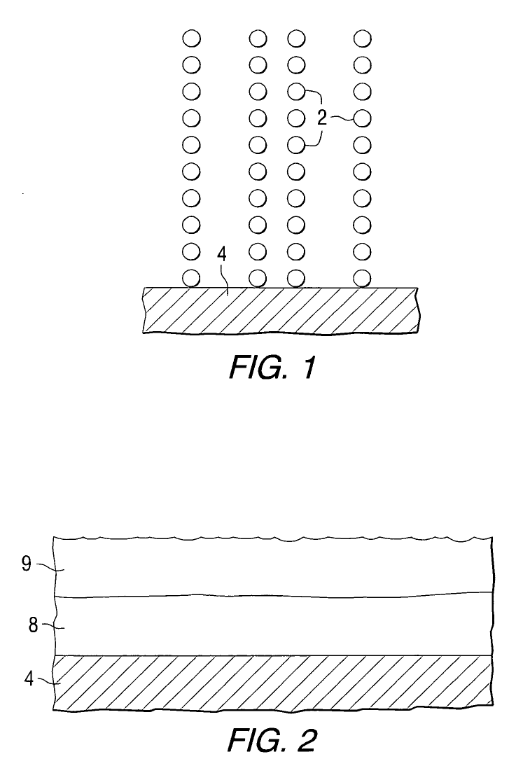

Heat transfer modes on the fuel surfaces, for pressurized water reactors, “PWR”, are normally force convection with some amount of sub-cooled nucleated boiling at the upper part of the core (see FIG. 1 as an example) where strings of bubbles 2 rise from the fuel cladding surface 4. FIG. 2 illustrates film boiling, where at higher heat fluxes, a water/steam layer 8 blankets the fuel cladding surface 4 between liquid water 9 and the heat transfer coefficient decreases. During nucleate boiling, there is the formation of small steam bubbles which rise from discrete points on a surface and almost immediately collapse as they migrate into the bulk fluid (water below the saturation temperature). However, if the generated heat flux gets too high, the coolant gets to the point where these bubbles coalesce and a film of water and steam 8 is formed over the surface of the fuel rods (called departure from nucleate boiling or DNB). In the example shown in FIG. 2, the difference between the surface temperature and the coolant could then rise over an order of magnitude (for example from about 32° C. to about 480° C.) when the heat flux reaches the critical heat flux (“CHF”). This temperature increase allows the fuel rod to reach the equilibrium between the generated heat rate and the cooling heat rate. Unfortunately, this equilibrium temperature exceeds in some cases the restricted temperature of metal based clad or metal based grids and the like. In addition to the temperature rise due to the deterioration of the heat transfer, (i.e. DNB and the subsequent steam film formed around the rod), the temperature increment and the steam film will rapidly increase the rate of clad oxidation. The zirconium oxidation reaction is an exothermic reaction resulting in a further increase of the clad temperature.

As a result of these undesirable conditions, the heat generation rate from nuclear fuel in a PWR is maintained low enough to provide sufficient margins so the occurrence of the departure from nucleate boiling during normal core operation and also during certain reactor transients like Loss of Flow, Locked Rotor or Steam Line Break remains limited or does not occur. Since the portions of the core in the center where new fuel is often added can have much higher heat transfer rates than the rest of the core, the overall power profile of the core is lowered so that this peak critical heat flux is well below that which will cause DNB at the hottest parts of the core. The power density of the core is therefore considerably below that which could be achieved if DNB restrictions were not a design criteria. Additionally, a rather complicated electronic control rod tripping mechanism has been proposed, as described in U.S. Pat. No. 5,631,937 (Robertson). However, this type of active safety approach is not as desirable as the passive approach of restricted heat flux. Similar restrictions are found in boiling water reactor “BWR” fuel where the criterion is to avoid dry-out of the fuel rods. This criterion also limits the reactor operation and is a result of the thermo mechanical properties of the current alloys employed in the cladding.

Obviously there is a need for much higher temperature resistant metals or other materials for cladding, grids, guide tubes, stainless control rods, and other uses in a nuclear reactor environment. One of the main objects of this invention is to provide substitute high heat flux rate resistant materials for use in nuclear reactor environments having the potential for departure from nucleate boiling. Another object is to substantially modify the design criteria and operation constraints by removing or reducing the DNB criterion by using resistant material that allow operations in film boiling conditions (DNB) for limited periods of time without substantive reduction of the mechanical integrity of the fuel rod.

### SUMMARY OF THE INVENTION

The above needs are fulfilled and the above objects met by providing an article of manufacture for use in the elevated temperature environment of a nuclear reactor, having a possibility of a departure from nucleate boiling, where the article is selected from structural forms within the nuclear reactor environment, such as at least one of cladding for nuclear fuel, support grids, guide tubes and control rods, where the article is coated with or made from a ceramic that is structurally and thermally resistant to temperatures that result from heat fluxes that cause a departure from nucleate boiling. Preferably the ceramic would have a melting point temperature over 1850° C. (about 3362° F.). The most preferred ceramic is SiC.

If the ceramic is to be a coating, over for example a metal alloy, it can be deposited onto the article using plasma spraying or chemical vapor deposition. If the entire article is to be ceramic, the article can be molded, extruded or built up using fibers, solid foam and/or liquid or gaseous precursors of the ceramic. The ceramic used can range from 50% to 100% of theoretical density usually 50% to 95%. The invention also resides in a structural member of any geometry made through any manufacturing technique in a nuclear reactor of any type having a possibility of a DNB, and in a nuclear reactor operating for short periods of time under departure from nucleate boiling having structural forms described above and hereinafter.

### BRIEF DESCRIPTION OF THE PREFERRED EMBODIMENT

The invention as set forth in the claims will become more apparent by reading the following detailed description in conjunction with the accompanying drawing, in which:

FIG. 1 is an idealized illustration of nucleate boiling;

FIG. 2 is an idealized illustration of film boiling;

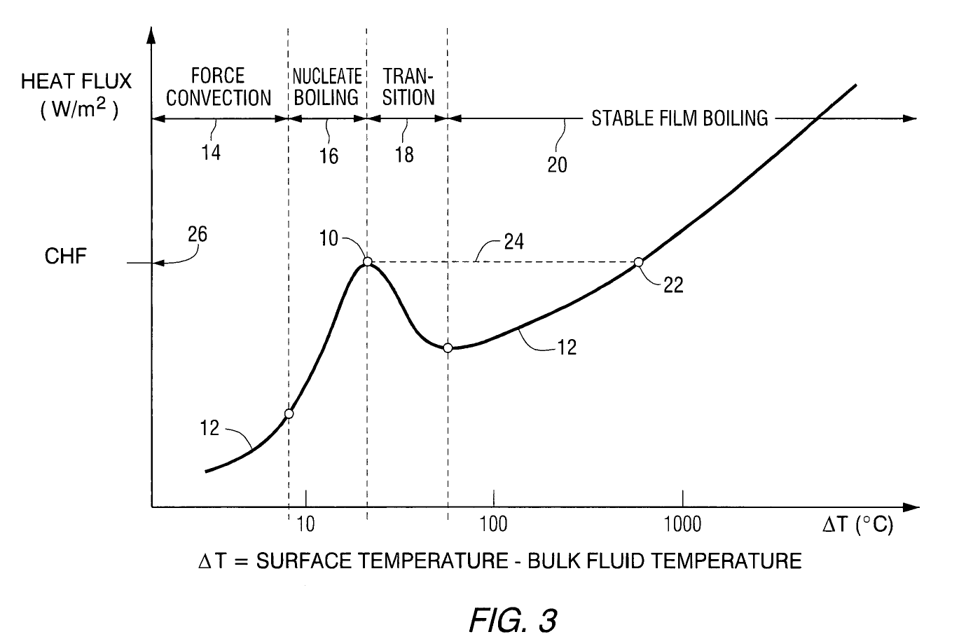

FIG. 3 is an example of a boiling heat transfer graph of heat flux vs. temperature difference for various heat transfer regimes in a water cooled nuclear reactor including the temperature difference during natural convection and various boiling stages;

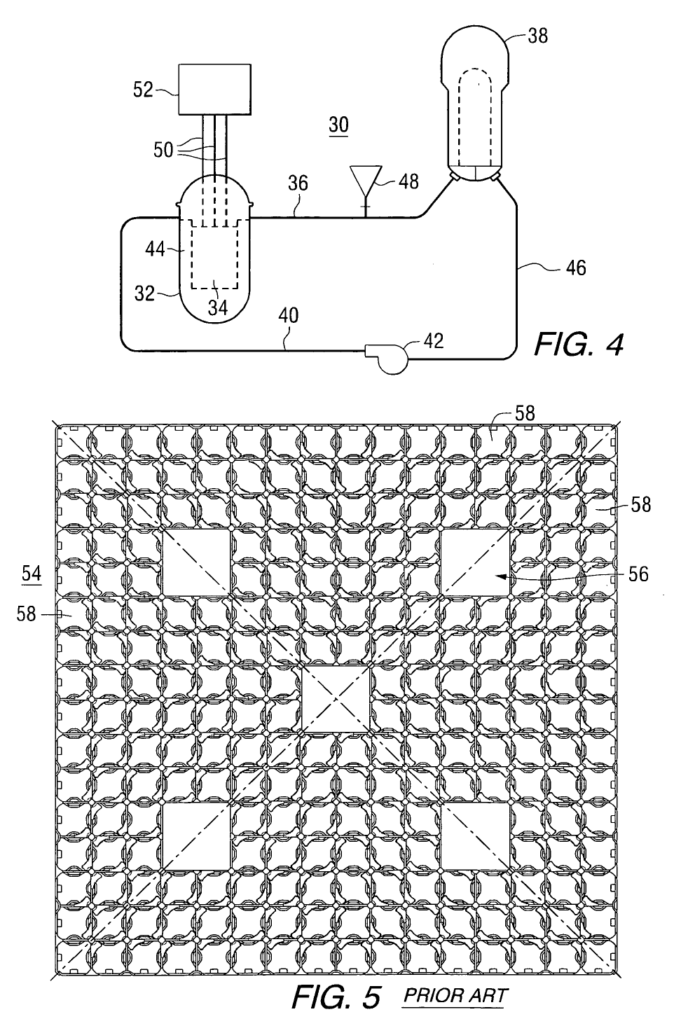

FIG. 4 is a simplified schematic drawing of a pressurized water nuclear reactor (“PWR”);

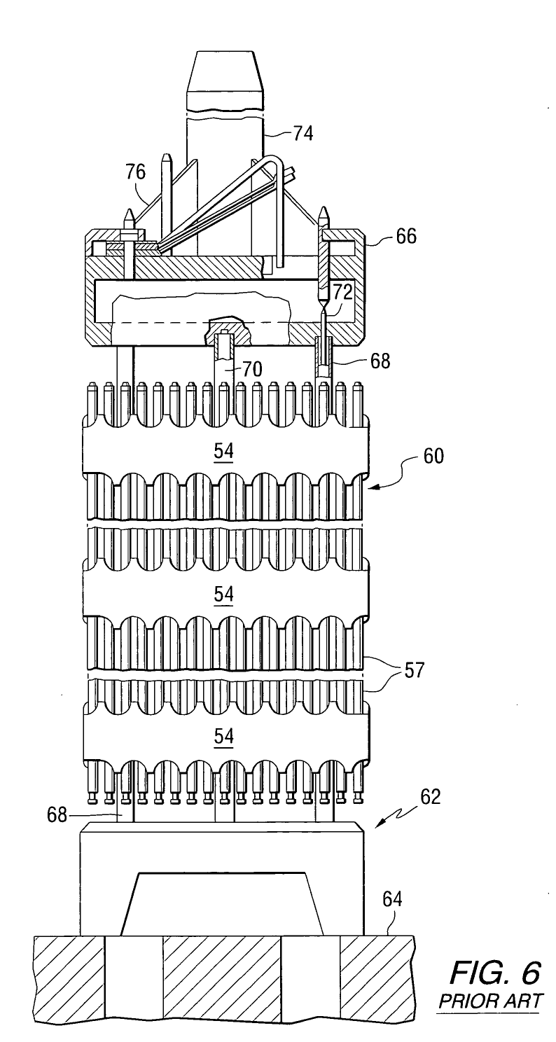

FIG. 5 is a top plan view of one type prior art grid structure for a nuclear reactor; and

FIG. 6, is a simplified schematic front view of one type prior art nuclear fuel assembly, showing some structural members and components of the nuclear fuel assembly.

### DESCRIPTION OF THE PREFERRED EMBODIMENT

FIGS. 1 and 2 have already been adequately discussed. FIG. 3 shows the heat transfer rate as a function of temperature difference, as described at http://www.tpub.com/content/doe/h1012v2/css/h1012v262to 65.htm, Nuclear Power Fundamentals, Integrated Publishing. The departure from nucleate boiling DNB point 10 on heat flux vs. temperature difference curve 12 shows where, in one example of the type of transition that can occur when the heat flux is increased and thus the fuel rod-cooling fluid interface get to the point where steam bubbles, as shown in FIG. 1, coalesce to form a steam film, as shown in FIG. 2, which leads to a large increase in the cladding temperature. Under such conditions, zirconium alloy cladding, and other metal components including stainless steel control rods will be oxidized with a resulting exothermic reaction further increasing metal temperature. Region 14 shows a force convection range, region 16 shows nucleate boiling range, region 18 shows transitional partial film boiling where heat flux drops from DNB, point 10 on curve 12, and region 20 shows complete stable film boiling where heat flux increases to point 22 which is at the same heat flux as the DNB point 10; and then curve 12 continues upward. In FIG. 3, Delta T (ΔT) is equal to surface temperature minus bulk fluid temperature. Note that the CHF value/point depends on many system parameters, such as temperature, pressure, flow rate, etc. The temperature/heat flux increase within the various regions can be caused by a sudden reduction of core coolant flow.

The term “nuclear reactor” is meant to include a pressurized water reactor (PWR), a boiling water reactor, a heavy water reactor and the like and any associated auxiliaries, such as turbine generators, fuel cell modules, and the like. The term “departure from nucleate boiling” (“DNB”), besides previous defining descriptions, is also meant to include, where in practice, if the heat flux is increased, the transition from nucleate boiling to film boiling occurs suddenly, and the temperature difference increases rapidly, as shown by the dashed line 24 in FIG. 3. The point of transition from nucleate boiling to film boiling is called the point of departure from nucleate boiling, commonly written as DNB. The heat flux associated with DNB is commonly called the critical heat flux (“CHF”) 26. In PWR/PHWR, CHF is an important parameter, and if the critical heat flux is exceeded and DNB occurs at any location in the core, the temperature difference required to transfer the heat being produced from the surface of the fuel rod to the reactor coolant increases greatly. If, as could be the case, the temperature increase causes the fuel rod to exceed its design limits, a failure will occur.

In a PWR, convective heat transfer is used to remove heat from a heat transfer surface. The liquid used for cooling is usually in a subcooled state, at a temperature lower than the normal saturation temperature for the working pressure. Under certain conditions, some type of local boiling can take place on the fuel rods. The most common type of local boiling encountered in nuclear facilities the nucleate boiling. In nucleate boiling, steam bubbles form at the heat transfer surface and then break away and are carried into the main stream of the fluid. Such movement enhances heat transfer because the heat generated at the surface is carried directly into the fluid stream. Once in the main fluid stream, the bubbles collapse if the bulk temperature of the fluid is below the saturation point. This heat transfer process is desirable because the energy created at the heat transfer surface is quickly and efficiently transferred to the bulk fluid.

As local heat flux increases, or due to a modification in the system parameters, such as the pressure/fluid enthalpy flow rate etc., could affect the rate of the creation of the bubbles from the heated surface, no longer assuring that the clad surfaces are continually wetted with liquid water. A transition from nucleate boiling to film boiling occurs and the CHF is reached.

Likewise, if the temperature of the heat transfer surface is increased, more bubbles are created. As the temperature continues to increase, more bubbles are formed than can be efficiently carried away. The bubbles grow and group together, covering small areas of the heat transfer surface with a film of steam. This is known as partial film boiling (18 in FIG. 3). Since steam has a lower convection heat transfer coefficient than water, the steam patches on the heat transfer surface act to insulate the surface making heat transfer more difficult.

As the area of the heat transfer surface covered with steam increases, the temperature of the heat transfer surface rapidly continues to increase until the affected surface is covered by a stable blanket of steam, preventing contact between the heat transfer surface and the liquid in the center of the flow channel. The condition after the stable steam blanket has formed is referred to as film boiling. The process of going from nucleate boiling to film boiling is graphically represented in FIG. 3. FIG. 3 illustrates the effect of boiling on the relationship between the heat flux and the temperature difference between the heat transfer surface and the fluid passing it (see Nuclear Power Fundamentalscited previously).

The approach of this invention is to enable the operation of high heat transfer fuel under DNB conditions, for limited periods, by using a clad or other structural material that has a limiting temperature for maintaining mechanical integrity well above the maximum temperature that is generated at the core hot spot during the reference transients. For example, during a locked rotor accident, the heat flux may be greater than the CHF of the DNB criteria and the temperature difference between the fuel surface and the coolant could rise to over 982° C. (1800° F.). This is well above the temperature value for zirconium based clad, where significant weakening occurs. The solution is to use a clad or other structural material/article such as a ceramic, for example, which has a melting point of >2700° C. (4,892° F.), a phase transition temperature of about 1900° C. (3,200° F.) which is well above the highest temperature difference that would give the required heat flux during most of the design basis accidents.

To further understand which articles/components in a nuclear reactor environment would benefit from being made from or coated with a ceramic having a melting point temperature over 1850° C. (such as SiC, the preferred ceramic of this invention); reference is made to FIG. 4, which shows one embodiment of a basic type of light water nuclear reactor, called a pressurized water nuclear reactor (“PWR”) 30. The PWR includes a reactor vessel 32 housing a reactor core 34 containing fissionable fuel. Reactor coolant in the form of light water is circulated upwardly through the reactor core 34 where it is heated by the fission reactions. The heated coolant is transferred through a reactor hot leg/conduit 36 to a steam generator 38 which utilizes the heat in the reactor coolant to generate steam in a secondary loop (not shown) which contains a turbine generator for generating electric power. It should be noted that FIG. 4 is not to be considered limiting, and similar articles in the nuclear environment could benefit from being made from or coated with a ceramic.

In the embodiment shown in FIG. 4, cooled reactor coolant is returned to the reactor vessel 32 through a reactor cold leg/conduit 40 by a reactor coolant pump 42. The cold leg discharges the coolant into a downcomer 44 for recirculation up through the core 34. While FIG. 4 illustrates a single primary loop including a single hot leg, steam generator, cold leg 46 and reactor coolant pump, in reality a PWR will have at least 2 such primary loops and in many instances three or four, all supplied with heated reactor coolant from a single reactor vessel. A pressurizer 48 serves as an accumulator to maintain operating pressure in the primary loop 46. A control system, of which only pertinent parts are shown, includes control rods 50 which can be inserted into reactor core 34 by a control rod drive mechanism 52 for shutting the reactor down, and in some instances, for controlling power level.

In most cooled water nuclear reactors, the reactor core is comprised of a large number of elongated fuel assemblies. These fuel assemblies typically include a plurality of fuel rods held in an organized array by a plurality of grids that are spaced axially along the fuel assembly length and are attached to a plurality of elongated thimble tubes of the fuel assembly. The thimble tubes typically receive control rods, plugging devices, or instrumentation therein.

FIG. 5 shows an example of a grid support matrix 54 within a reactor fuel assembly. The fuel rods containing nuclear fuel pellets surrounded by a protective cladding, most usually a zirconium based alloy, are held in spaced relationship with one another within the grid cells 58. The fuel pellets are composed of fissile material that fissions in a nuclear reaction and is responsible for creating the thermal energy of the nuclear reactor. This and the following figure are illustrations of a prior art design shown in Smith et al., U.S. Pat. No. 6,606,369B1.

A side view of the fuel assembly is shown in FIG. 6. There, a schematically depicted fuel assembly 60 is mounted in the core of a schematically depicted nuclear reactor vessel. The fuel assembly 60 includes a grid support matrix shown generally as 54. A bottom nozzle 62 supports the fuel assembly 60 on a lower core support plate 64 in the core region of the nuclear reactor. The nuclear reactor in this case is a pressurized water reactor that includes a plurality of the fuel assemblies 60 mounted on the core support plate 64. In addition to the bottom nozzle 62, the structural skeleton of the fuel assembly 60 also includes a top nozzle 66 at its upper end and a number of elongated guide tubes or thimble tubes 68 which extend longitudinally between the bottom and top nozzles 62 and 66. The fuel assembly 60 further includes an organized array of elongated fuel rods 57 transversely spaced and supported by the grid matrix 54. Also, the fuel assembly 60 has an instrumentation tube 70 located in the center thereof that extends between the bottom and top nozzles.

A liquid moderator/coolant such as water, or water containing lithium and boron, is pumped upwardly through a plurality of flow openings in the lower core plate 64 to the fuel assembly 60. The bottom nozzle 62 of the fuel assembly 60 passes the coolant flow upwardly through the thimble tubes 68 and along the fuel rods of the assembly in order to extract heat generated therein for the production of useful work.

To control the fission process, a number of control rods 72 are reciprocally movable in the thimble tubes 68 located at predetermined positions 56 in FIG. 5, in the fuel assembly. Specifically, a rod cluster control mechanism 74 positioned above the top nozzle 66 supports the control rods 72. The control mechanism has an internally threaded cylindrical member 74 with a plurality of radially extending arms 76. All of the metal components could be subject to “melt down” if the temperature and heat flux goes beyond DNB to complete film boiling and the CHFT point. Most of these and other associated components/articles can be made from or coated with the specific ceramics described below to lower the risk of such “melt down”.

The “structural forms” located within the nuclear reactor environment that are coated with or made from the ceramic of this invention are defined to include at least one of cladding for nuclear fuel, support or mixing grids for clad nuclear fuel, guide tubes (thimble tubes), control rods, lower core support plates, top and bottom nozzles, and instrumentation tubes and the like. Examples of useful ceramics include SiC (melting point >2700° C.); ZrO₂ (zirconia, melting point 2700° C.); Al₂O₃ (alumina, melting point 1900° C.); ZrN (melting point 2930° C.); and AlN (aluminum nitride, melting point 2200° C. at 4 atm and mixtures thereof.

Thus any ceramic type material having a melting point over 1850° C. is useful as the coating or substitute whole article. The preferred materials based on cost/performance are SiC, ZrO₂ and ZrN. The most preferred material is SiC. Use of these materials also allows from a 5% to 30% uprate in the power density achievable over metal clad fuel rods without running the risk of the geometrical failure of the fuel during a design basis accident. That is, normal power density for zirconium alloy clad fuel assemblies is about 5 to 10 kw/A. Above this value during a design basis accident, the surface temperature of the clad and perhaps the surrounding grids could exceed the melting point of the clad. However, even at the uprated condition, the clad surface temperature will not exceed the service temperature of the ceramic.

These ceramic type materials are within required radiation, temperature, mechanical and corrosion characteristics required in the nuclear reactor environment. Of course only part of the structural forms need be coated or made entirely of a ceramic type material, for example, the cladding can be coated with or made from ceramic, but the grid can be metal. Thus at least one structural form may contain ceramic and a plurality of other forms may remain metal.

If the previously described materials are to be coated onto a metal surface by coating means such as plasma spraying, chemical vapor deposition or chemical reaction, the thickness should range from 0.01 mm to 10 mm at a density of from 50% to 100% of theoretical density. Over 10 mm and the coating will likely flake off and hinder heat transfer. Under 0.01 mm and there will be insufficient protection of the metal surface from corrosion. Under 50% density and the coating will be too porous for protecting the underlying metal.

If the previously described materials are to be 100% ceramic, that is, for example, all ceramic fuel cladding etc., made by means such as pressing of powders into tubes, winding of tubes from fiber mats, or other forms of the ceramic that have been hardened using a ceramic precursor chemical, then their density should be from 50% to 100% of theoretical density. Under 50% and the tubes will not be gas tight or have sufficient strength.

Having described the presently preferred embodiments, it is to be understood that the invention may be otherwise embodied within the scope of the appended claims.

What is claimed is:

1. An article of manufacture for use in an elevated temperature environment of a nuclear reactor, having a possibility of a departure from nucleate boiling, where the article is selected from structural forms within the nuclear reactor environment, where the article is coated with or made from a ceramic that is structurally and thermally resistant to temperatures that result from heat fluxes in the range that cause a departure from nucleate boiling.

2. The article of manufacture of claim 1, wherein the structural forms are selected from the group of at least one of cladding for nuclear fuel, support or mixing grids for clad nuclear fuel, guide tubes, control rods, lower core support plates, top and bottom nozzles and instrumentation tubes.

3. The article of manufacture of claim 1, wherein the article can be used in a water cooled reactor selected from the group consisting of a pressurized water reactor, a heavy water reactor, and a boiling water reactor; and the structural forms are selected from at least one of cladding for nuclear fuel and support or mixing grids for clad nuclear fuel.

4. The article of manufacture of claim 1, wherein the article is coated with the ceramic.

5. The article of manufacture of claim 1, wherein the article is made from the ceramic.

6. The article of manufacture of claim 1, wherein the ceramic has a melting point temperature over 1850° C.

7. The article of manufacture of claim 1, wherein the ceramic is selected from the group consisting of SiC, ZrO₂, Al₂O₃ Si₃N₄, ZrN, AlN and mixtures thereof.

8. The article of manufacture of claim 1, wherein the ceramic is selected from the group consisting of SiC, ZrO₂, ZrN and mixtures thereof.

9. The article of manufacture of claim 1, wherein the ceramic is SiC.

10. The article of manufacture of claim 3, wherein the density of the ceramic of the article is from 50% to 100% of theoretical density.

11. The article of manufacture of claim 4, wherein the density of the ceramic article is from 50% to 95% of theoretical density.

12. A nuclear water reactor having a possibility of operating for short periods of time under departure from nucleate boiling, having structural forms within the reactor, where at least one of the structural forms is coated with or made from a ceramic having a melting point temperature over 1850° C.

13. The nuclear reactor of claim 12, wherein the structural forms are selected from the group of at least one of cladding for nuclear fuel, support or mixing grids for clad nuclear fuel, guide tubes, control rods, lower core support plates, top and bottom nozzles and instrumentation tubes.

14. The nuclear reactor of claim 11, wherein the structural forms are selected from at least one of cladding for nuclear fuel and support or mixing grids for clad nuclear fuel.

15. The nuclear reactor of claim 11, wherein the ceramic has a melting point temperature over 1850° C.

16. The nuclear reactor of claim 11, wherein the ceramic is selected from the group consisting of SiC, ZrO₂, Al₂O₃ Si₃N₄, ZrN, AlN and mixtures thereof.

17. The nuclear reactor of claim 11, wherein the ceramic is selected from the group consisting of SiC, ZrO₂, ZrN and mixtures thereof.

18. The nuclear reactor of claim 12, wherein some of the structural forms will be made solely of metal.
